(19) United States
(12) Patent Application Publication
(10) Pub. No.: US 2017/0046168 A1
(43) Pub. Date: Feb. 16, 2017

(54) SCALABLE SINGLE-INSTRUCTION-MULTIPLE-DATA INSTRUCTIONS

(71) Applicant: QUALCOMM INCORPORATED, San Diego, CA (US)

(72) Inventor: Eric Wayne Mahurin, Austin, TX (US)

(21) Appl. No.: 14/827,170

(22) Filed: Aug. 14, 2015

(51) Int. Cl. G06F 9/38; G06F 15/80

(52) U.S. Cl. CPC G06F 9/3887; G06F 15/8007

(57) ABSTRACT

A method for executing scalable single-instruction-multiple-data (SIMD) instructions includes performing a query to determine a hardware vector length of a SIMD processor. The method also includes scaling a first instruction of the scalable SIMD instructions to a first scaled vector length to generate a first scaled instruction. The first scaled vector length is based on the hardware vector length, and the first instruction is a compiled instruction having an adaptable vector length. The method also includes adjusting a first number of iterations to be used by the SIMD processor to perform first operations associated with the first instruction based on the first scaled vector length.

### I. FIELD

The present disclosure is generally related to single-instruction-multiple-data (SIMD) instructions. More specifically, the present disclosure is related to executing SIMD instructions on SIMD hardware.

### II. DESCRIPTION OF RELATED ART

Advances in technology have resulted in smaller and more powerful computing devices. For example, there currently exist a variety of portable personal computing devices, including wireless telephones such as mobile and smart phones, tablets, and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Wireless telephones and other electronic devices may execute single-instruction-multiple-data (SIMD) software on SIMD hardware. For example, SIMD instructions may be executed by a SIMD processor having a particular vector length. The vector length of data in a SIMD instruction may be larger than a hardware vector length of the SIMD processor. Thus, the SIMD processor may execute the data in the SIMD instructions using multiple iterations (e.g., loops). To illustrate, a SIMD instruction having 2048 words (where a word is 32 bits) may be executed by a SIMD processor having a 128-bit hardware vector length. The SIMD processor may be capable of processing four words at a time. Thus, the SIMD processor may execute the 2048 words over 512 iterations.

As the hardware vector length of SIMD hardware increases, the SIMD processors may execute SIMD instructions using fewer iterations. However, in some scenarios, SIMD processors may adapt to the vector length of SIMD software. For example, the SIMD software may encode the vector length in operational code (e.g., “opcode”) and instruct the SIMD hardware to perform a particular number of iterations based on the encoded vector length. Thus, the number of iterations performed by the SIMD hardware may be based on the operational code in the SIMD software as opposed to being based on processing capabilities of the SIMD hardware.

### III. SUMMARY

Techniques and methods to adjust a number of processing iterations (e.g., loops) for executing a single-instruction-multiple-data (SIMD) instruction based on processing capabilities of a SIMD processor are disclosed. A processor may perform a query to determine a hardware vector length of a SIMD processor. The hardware vector length may be indicative of how many words the SIMD processor may execute at a time. For example, if the hardware vector length is 128 bits, the SIMD processor may process four words at a time (assuming that one word includes 32 bits). According to one implementation, the processor may perform the query by polling a control register. According to another implementation, the processor may perform the query by executing a dedicated scalar instruction. According to yet another implementation, the processor may perform the query by executing hypervisor code to retrieve a value indicative of the hardware vector length. In yet another implementation, the processor may perform the query by performing a library call to access hardware specification data that indicates the hardware vector length.

After determining the hardware vector length, the processor may scale one or more scalable SIMD instructions to a vector length that corresponds to the hardware vector length. For example, if the hardware vector length is 128 bits, the processor may scale each scalable SIMD instruction to a 128-bit vector length (e.g., a four word vector length) to generate scaled instructions. The processor may also adjust a number of iterations to be used by the SIMD processor based on the scaled instructions. Because the hardware vector length and the vector length of the scaled instructions are equal, processing resources of the SIMD processor may be efficiently utilized for each processing cycle. Thus, the number of iterations for processing the scalable SIMD instructions may be adjusted (e.g., reduced) compared to a number of iterations when the hardware vector length is greater than the vector length of the executed instructions.

According to one implementation of the disclosed techniques, a method for executing scalable single-instruction-multiple-data (SIMD) instructions includes performing a query to determine a hardware vector length of a SIMD processor. The method also includes scaling a first instruction of the scalable SIMD instructions to a first scaled vector length to generate a first scaled instruction. The first scaled vector length is based on the hardware vector length, and the first instruction is a compiled instruction having an adaptable vector length. The method also includes adjusting a first number of iterations to be used by the SIMD processor to perform first operations associated with the first instruction based on the first scaled vector length.

According to another implementation of the disclosed techniques, an apparatus includes a processor configured to retrieve a first single-instruction-multiple-data (SIMD) instruction and to scale the first SIMD instruction to a first scaled vector length to generate a first scaled instruction. The first scaled vector length is based on a hardware vector length of a SIMD processor. The first SIMD instruction is a compiled instruction having an adaptable vector length. The apparatus also includes a loop value register storing a control value that indicates a number of iterations to be used by the SIMD processor to perform operations associated with the first SIMD instruction. The control value is adjusted based on the first scaled vector length.

According to another implementation of the disclosed techniques, a non-transitory computer-readable medium includes commands for executing scalable single-instruction-multiple-data (SIMD) instructions. The commands, when executed by a processor, cause the processor to perform operations. The operations include performing a query to determine a hardware vector length of a SIMD processor. The operations also include scaling a first instruction of the scalable SIMD instructions to a first scaled vector length to generate a first scaled instruction. The first scaled vector length is based on the hardware vector length, and the first instruction is a compiled instruction having an adaptable vector length. The operations also include adjusting a first number of iterations to be used by the SIMD processor to perform first operations associated with the first instruction based on the first scaled vector length.

One particular advantage provided by at least one of the disclosed techniques is an ability to adjust a number of processing iterations (e.g., loops) for executing a single-instruction-multiple-data (SIMD) instruction based on processing capabilities of a SIMD processor (as opposed to based on operational code in a SIMD instruction). Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 includes a diagram of a scaling process for scaling single-instruction-multiple-data (SIMD) instructions to different vector lengths;

FIG. 2 includes a diagram of a system that is operable to scale SIMD instructions to different vector lengths;

FIG. 3 is a flowchart of a method for scaling SIMD instructions to different vector lengths; and

FIG. 4 is a block diagram of a device including execution hardware that is operable to scale SIMD instructions to different vector lengths.

### V. DETAILED DESCRIPTION

Particular aspects of the present disclosure are described with reference to the drawings. In the description, common features are designated by common reference numbers throughout the drawings.

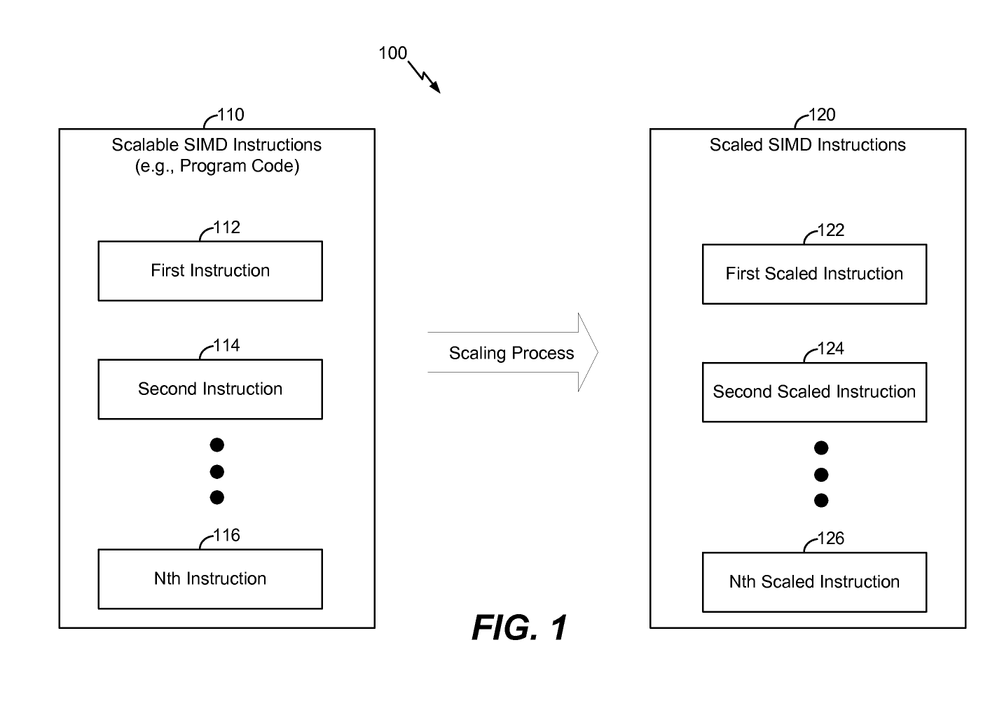

Referring to FIG. 1, a scaling process 100 for scaling single-instruction-multiple-data (SIMD) instructions to different vector lengths is shown. For example, scalable SIMD instructions 110 may undergo the scaling process 100 to generate scaled SIMD instructions 120.

The scalable SIMD instructions 110 (e.g., program code) may include a first instruction 112 (e.g., a first SIMD instruction), a second instruction 114 (e.g., a second SIMD instruction), and an Nth instruction 116 (e.g., an Nth SIMD instruction). Each instruction 112, 114, 116 may be a compiled instruction having an adaptable vector length. For example, each instruction 112, 114, 116 may have a non-specified (or variable) vector length that is adaptable (by a processor) for run-time processing. To illustrate, each instruction 112, 114, 116 may be compiled to have multiple vector lengths (where a specific vector length is determined during run-time processing) to enable a processor to reduce a number of processing iterations during run-time processing, as described below. In a particular implementation, N may correspond to any integer that is greater than zero. For example, if N is equal to eight, the scalable SIMD instructions 110 may include eight SIMD instructions.

Each instruction 112-116 of the scalable SIMD instructions 110 may specify data that is to be processed by a SIMD processor (not shown). As a non-limiting example, each instruction 112-116 of the scalable SIMD instructions 110 may be configured to cause the SIMD processor to process 2048 words of input data, where each word includes 32 bits of data. If the SIMD processor has a hardware vector length of 64 bits, the SIMD processor may be capable of processing two words (e.g., 64 bits) at a time. Thus, if each instruction 112-116 has a vector length of two words, the SIMD processor may execute each instruction 112-116 over 1024 iterations (e.g., loops) if 64 bits are processed by the SIMD processor during each iteration.

However, if the SIMD processor has a hardware vector length of 128 bits, the SIMD processor may be capable of processing four words during each iteration. Thus, the number of iterations to process a 2048 word instruction may be reduced by half based on the processing capabilities (e.g., the hardware vector length) of the SIMD processor. To accommodate the increased processing capabilities of the SIMD processor, the scalable SIMD instructions 110 may undergo the scaling process 100 to scale each instruction 112-116 based on the hardware vector length of the SIMD processor.

For example, each instruction 112-116 may be scaled from having a vector length of two words (e.g., 64 bits) to having a vector length of four words (e.g., 128 bits). Thus, the first instruction 112 (e.g., a SIMD instruction having a vector length of 64 bits) may be scaled to generate a first scaled instruction 122 (e.g., a SIMD instruction having a vector length of 128 bits). In a similar manner, the second instruction 114 (e.g., a SIMD instruction having a vector length of 64 bits) may be scaled to generate a second scaled instruction 124 (e.g., a SIMD instruction having a vector length of 128 bits), and the Nth instruction 116 (e.g., a SIMD instruction having a vector length of 64 bits) may be scaled to generate an Nth scaled instruction 126 (e.g., a SIMD instruction having a vector length of 128 bits). Thus, according to one implementation, “scaling an instruction” as used herein may include using an actual hardware vector length for the vector length parameter of the instruction behavior.

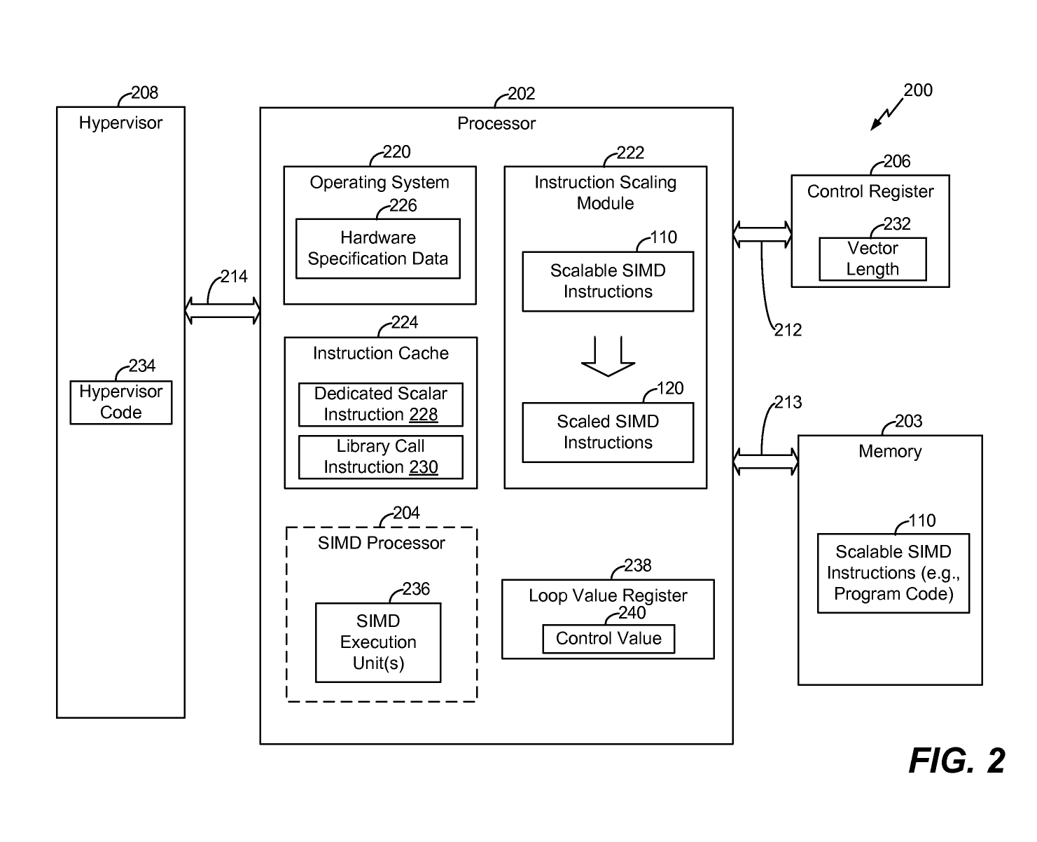

As described below with respect to FIG. 2, a processor may perform a query to determine the hardware vector length of the SIMD processor. According to some implementations, the query may be performed at run-time. For example, the query may be performed after the operational code (e.g., the “op-code”) of the scalable SIMD instructions 110 has been generated. The instructions 112-116 may be scaled based on the hardware vector length of the SIMD processor to increase efficiency of use of the processing resources in the SIMD processor. For example, the instructions 112-116 may be scaled to generate the scaled instructions 122-126, respectively, that have vector lengths that are equal to the hardware vector length of the SIMD processor.

The scaling process 100 of FIG. 1 may enable a SIMD processor to adjust (e.g., reduce) a number of processing iterations (e.g., loops) for executing SIMD instructions based on processing capabilities of the SIMD processor (as opposed to based on operational code in a SIMD instruction). For example, the scaling process 100 may scale the instructions 110-116 based on the vector length of the SIMD processor to enable the SIMD processor to “fully” utilize its processing resources during each iteration.

Referring to FIG. 2, a system 200 that is operable to scale SIMD instructions to different vector lengths is shown. The system 200 includes a processor 202, a memory 203, a control register 206, and a hypervisor 208 (e.g., a virtual machine monitor). Although the system 200 is shown to include the processor 202, the memory 203, the control register 206, and the hypervisor 208, in some implementations, the system 200 may include additional or fewer components. As a non-limiting example, in some implementations, the control register 206 and/or the hypervisor 208 may be absent from the system 200.

The processor 202 is communicatively coupled to the control register 206 via a bus 212, and the processor 202 is communicatively coupled to the hypervisor 208 via a bus 214. The memory 203 is communicatively coupled to the processor 202 via a bus 213. The memory 203 may store the scalable SIMD instructions 110 of FIG. 1.

The processor 202 includes an SIMD processor 204 (e.g., SIMD processing components), an instruction cache 224, an instruction scaling module 222, and a loop value register 238. The processor 202 may run an operating system 220. For example, the operating system 220 may provide instructions for the processor 202 to execute. Although the SIMD processor 204 is illustrated as being integrated into the processor 202, in other implementations, the SIMD processor 204 may be distinct from the processor 202 and coupled to the processor 202 via a bus. The SIMD processor 204 may include one or more SIMD execution units 236. The operating system 220 may include hardware specification data 226 that indicates the vector length of the SIMD processor 204. The instruction cache 224 may include a dedicated scalar instruction 228 or a library call instruction 230.

The processor 202 may be configured to perform a query to determine a hardware vector length of the SIMD processor 204. As used herein, the “hardware vector length” of the SIMD processor 204 may correspond to an amount of data that one of the SIMD execution units 236 is capable of processing during a processing cycle. For example, if one of the SIMD execution units 236 is capable of processing 64 bits of data (e.g., 2 words) during a processing cycle, the hardware vector length of the SIMD processor 204 may be 64 bits. As another example, if one of the SIMD execution units 236 is capable of processing 128 bits of data (e.g., 4 words) during a processing cycle, the hardware vector length of the SIMD processor 204 may be 128 bits.

According to one implementation, the processor 202 may poll the control register 206 to determine the hardware vector length. For example, the control register 206 may store data indicating a vector length 232 of the SIMD processor 204. The processor 202 may send a poll signal to the control register 206 via the bus 212 to access the data. Based on the poll signal, the processor 202 may determine the vector length 232 (e.g., the hardware vector length) of the SIMD processor 204.

According to one implementation, the processor 202 may execute the dedicated scalar instruction 228 to determine the hardware vector length of the SIMD processor 204. For example, the processor 202 may fetch the dedicated scalar instruction 228 from the instruction cache 224. After fetching the dedicated scalar instruction 228, the processor 202 may execute the dedicated scalar instruction 228 to determine the hardware vector length of the SIMD processor 204. To illustrate, upon executing the dedicated scalar instruction 228, the processor 202 may poll a register (e.g., the control register 206 or another register (not shown)) to access data indicating the hardware vector length of the SIMD processor 204.

According to one implementation, the processor 202 may execute hypervisor code 234 to retrieve a value that indicates the hardware vector length of the SIMD processor 204. The hypervisor 208 may “support” the processor 202 and the SIMD processor 204. For example, the hypervisor 208 may store information (e.g., hardware specification information) associated with the processor 202 and the SIMD processor 204. To illustrate, the hypervisor 208 may store the hardware vector length of the SIMD processor 204 as hypervisor code 234 that may be executed and translated into a machine language of the processor 202. Thus, the processor 202 may execute the hypervisor code 234 to determine the hardware vector length of the SIMD processor 204.

According to one implementation, the processor 202 may perform a library call to access the hardware specification data 226. For example, the processor 202 may fetch a library call instruction 230 from the instruction cache 224. After fetching the library call instruction 230, the processor 202 may execute the library call instruction 230 to access hardware specification data 226. The hardware specification data 226 may indicate the hardware vector length of the SIMD processor 204. After determining the hardware vector length of the SIMD processor 204, the processor 202 may be configured to scale the first instruction 112 of the scalable SIMD instructions 110 to a first scaled vector length to generate the first scaled instruction 122. The first scaled vector length may be based on the hardware vector length of the SIMD processor 204. For example, if the hardware vector length of the SIMD processor 204 is 128 bits, the first scaled vector length may be equal to 128 bits.

To illustrate, the instruction scaling module 222 may fetch the scalable SIMD instructions 110 from the memory 203 via the bus 213. Upon fetching the scalable SIMD instructions 110, the instruction scaling module 222 may perform the scaling process 100 described with respect to FIG. 1. For example, the instruction scaling module 222 may scale the first instruction 112 from having a vector length of two words (e.g., 64 bits) to having a vector length of four words (e.g., 128 bits). Additionally, the instruction scaling module 222 may be configured to scale the second instruction 114 to the first scaled vector length to generate the second scaled instruction 124. In a similar manner, the instruction scaling module 222 may be configured to scale the Nth instruction 116 to the first scaled vector length to generate the Nth scaled instruction 126. Thus, the instructions scaling module 222 may generate the scaled SIMD instructions 120 based on the vector length of the SIMD processor 204 (e.g., the first scaled vector length). According to one implementation, scaling each instruction 112-116 may include replacing a vector length parameter in the corresponding instruction 112-116 with a vector length parameter of the SIMD processor. For example, the vector length parameter in each instruction 112-116 may be “treated as” the vector length of the SIMD processor (e.g., the vector length of the hardware).

Although the instruction scaling module 222 is described as scaling the instructions 112-116 to the first scaled vector length (e.g., 128 bits), in some implementations, the instruction scaling module 222 may scale the instructions 112-116 to a second scaled vector length that is less than the first scaled vector length or to a third scaled vector length that is greater than the first scaled vector length. For example, if the processor 202 determines that the hardware vector length of the SIMD processor 204 is 32 bits (e.g., one word), the instruction scaling module 222 may scale the instructions 112-116 to the second scaled vector length (e.g., 32 bits). Alternatively, if the processor 202 determines that the hardware vector length of the SIMD processor 204 is 256 bits (e.g., eight words), the instruction scaling module 222 may scale the instructions 112-116 to the third scaled vector length (e.g., 254 bits).

After scaling the instructions 112-116 to generate the scaled SIMD instructions 120, the processor 202 may be configured to adjust a number of iterations (e.g., loops) to be used by the SIMD processor 204 to perform operations associated with scaled instructions 122-126. For example, the loop value register 238 may store a control value 240 that indicates the number of iterations (e.g., loops) that the one or more SIMD execution units 236 are to perform to execute the instructions. The processor 202 may send a signal to the loop value register 238 to adjust the control value 240 based on the first scaled vector length (e.g., the hardware vector length of the SIMD processor 204). For example, if each instruction 112-116 includes 2048 words, the processor 202 may adjust the control value 240 to indicate that 512 iterations are to be used by the execution units 236 to perform operations associated with each instruction 112-116.

After the processor 202 adjusts the control value 240, the processor 202 may be configured to initiate execution of the scaled instructions 122-126 at the SIMD processor 204. For example, the processor 202 may provide the scaled SIMD instructions 120 to the one or more SIMD execution units 236, and the one or more SIMD execution units 236 may execute the scaled instructions 122-126 based on the adjusted number of iterations indicated by the control value 240. In some implementations, the processor 202 may provide the scaled SIMD instructions 120 to the memory 203, and the SIMD processor 204 may retrieve the scaled SIMD instructions 120 from the memory 203.

The system 200 of FIG. 2 may enable the SIMD processor 204 to adjust a number of processing iterations (e.g., loops) for executing SIMD instructions based on the hardware vector length of the SIMD processor 204 and based on the number of elements to be executed. For example, the instruction scaling module 222 may scale the instructions 110-116 based on the vector length of the SIMD processor 204 to enable the SIMD processor 204 to “fully” utilize its processing resources during each iteration. For example, the SIMD processor 204 may utilize each SIMD execution unit 236 during each iteration to reduce the number of processing iterations.

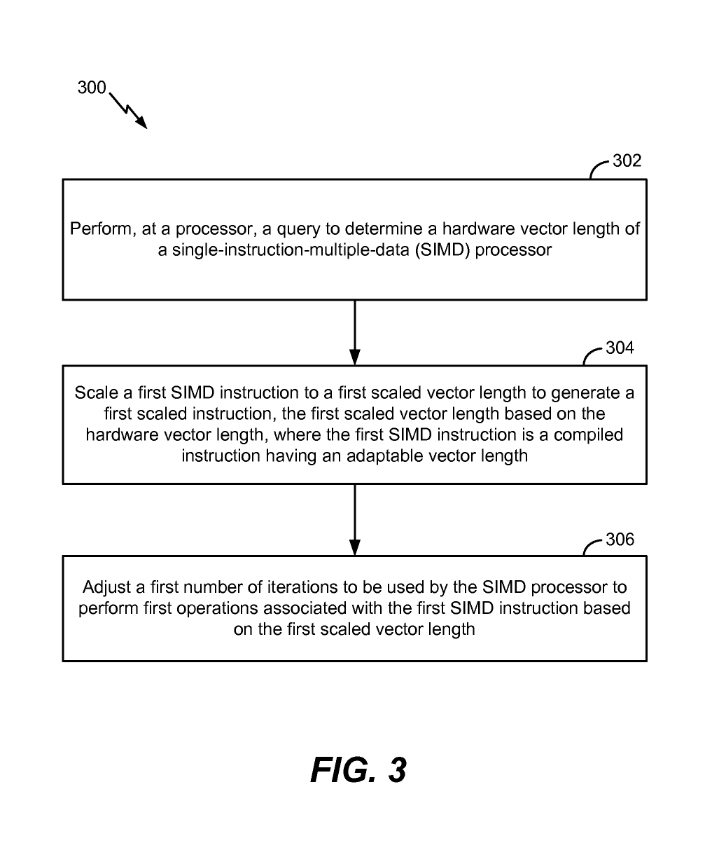

Referring to FIG. 3, a flowchart of a method 300 for scaling SIMD instructions to a different vector length is shown. The method 300 may be performed using the system 200 of FIG. 1.

The method 300 includes performing, at a processor, a query to determine a hardware vector length of a SIMD processor, at 302. For example, referring to FIG. 2, the processor 202 may perform a query to determine the hardware vector length of the SIMD processor 204. According to one implementation, the processor 202 may poll the control register 206 to determine the hardware vector length. According to another implementation, the processor 202 may execute the dedicated scalar instruction 228 to determine the hardware vector length of the SIMD processor 204. According to yet another implementation, the processor 202 may execute the hypervisor code 234 to retrieve a value that indicates the hardware vector length of the SIMD processor 204. According to another implementation, the processor 202 may perform a library call to access the hardware specification data 226. The hardware specification data 226 may indicate the hardware vector length of the SIMD processor 204.

According to another implementation, the processor 202 may send a software request for a range of hardware vector lengths for available resources. The software request may be sent to a library or to the operating system 220. In response to sending the software request, the processor 202 may receive a signal indicating the hardware vector length of the SIMD processor 204 when the SIMD processor 204 is available to process data (e.g., when one or more of the SIMD execution unit 236 is available to process instructions). According to yet another implementation, the processor 202 may send a software request for a particular hardware vector length of an available resource. For example, the processor 202 may send a software request for a particular SIMD execution unit 236. The software request may be sent to the library or to the operating system 220. In response to sending the software request, the processor 202 may receive a signal indicating the particular hardware vector length of the particular SIMD execution unit 236 when the particular SIMD execution unit 236 is available to process data.

A first SIMD instruction may be scaled to a first scaled vector length to generate a first scaled instruction, at 304. The first scaled vector length may be based on the hardware vector length, and the first SIMD instruction may be a compiled instruction having an adaptable vector length. For example, referring to FIG. 2, if the hardware vector length of the SIMD processor 204 is 128 bits, the instruction scaling module 222 may scale the first instruction 112 to the first scaled vector length (e.g., 128 bits) to generate the first scaled instruction 122.

A first number of iterations to be used by the SIMD processor to perform first operations associated with the first SIMD instruction may be adjusted based on the first scaled vector length, at 306. For example, referring to FIG. 2, the processor 202 may send a signal to the loop value register 238 to adjust the control value 240 based on the first scaled vector length. The control value 240 may indicate the first number of iterations to be used by the SIMD processor 204 to perform first operations associated with the first instruction 112. For example, the control value 240 may indicate the number of loop iterations the one or more execution units 236 is to use to execute the first scaled instruction 122.

According to one implementation, the method 300 may also include initiating execution of the first scaled instruction 122 at the SIMD processor 204. For example, the processor 202 may provide the first scaled instruction 122 to the SIMD processor 204, and the one or more SIMD execution units 236 may execute the first scaled instruction 122 based on the adjusted number of iterations indicated by the control value 240.

According to one implementation, the second instruction 114 may be scaled in the same manner as the first instruction with respect to the method 300.

The method 300 of FIG. 3 may enable the SIMD processor 204 to adjust (e.g., reduce) a number of processing iterations (e.g., loops) for executing SIMD instructions based on the hardware vector length of the SIMD processor 204. For example, the instruction scaling module 222 may scale the instructions 110-116 based on the vector length of the SIMD processor 204 to enable the SIMD processor 204 to “fully” utilize its processing resources during each iteration. For example, the SIMD processor 204 may utilize each execution unit 236 during each iteration to reduce the number of processing iterations.

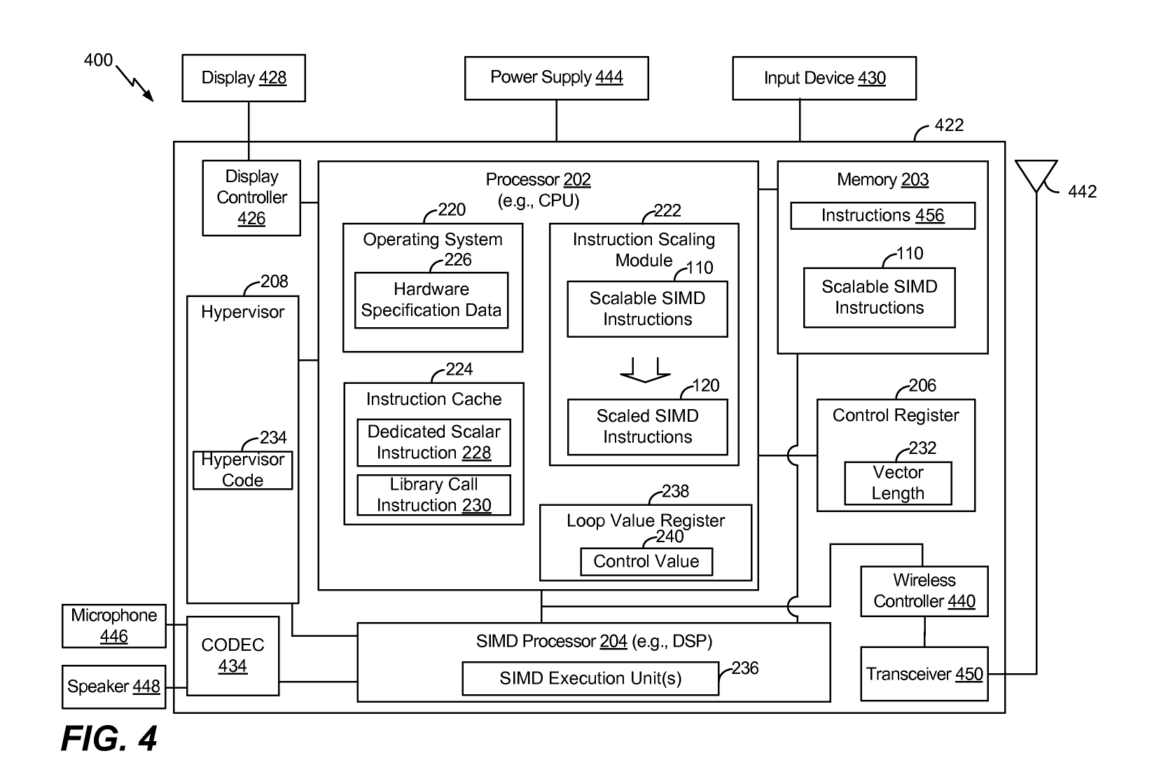

Referring to FIG. 4, a block diagram of a device (e.g., a computing device) is depicted and generally designated 400. In various implementations, the device 400 may have fewer or more components than illustrated in FIG. 4. In an illustrative implementation, the device 400 may include the system 200 of FIG. 2. For example, the device 400 may include the processor 202, the memory 203, the SIMD processor 204, the control register 206, and the hypervisor 208. According to one implementation, the processor 202 may be a central processing unit (CPU), and the SIMD processor 204 may be a digital signal processor (DSP). Although the SIMD processor 204 is shown to be separate from the processor 202 in FIG. 4, in other implementations, the SIMD processor 204 may be integrated with the processor 202, as described with respect to FIG. 2.

A wireless controller 440 may be coupled to an antenna 442 via transceiver 450. The device 400 may include a display 428 coupled to a display controller 426. A speaker 448, a microphone 446, or both may be coupled to a coder/encoder (CODEC) 434.

The memory 203 may include instructions 456 executable by the processor 202, the SIMD processor 204, another processing unit of the device 400, or a combination thereof, to perform the method 300 of FIG. 3. One or more components of the system 200 of FIG. 2 may be implemented via dedicated hardware (e.g., circuitry), by a processor executing instructions to perform one or more tasks, or a combination thereof. As an example, the memory 203 or one or more components of the processor 202 and/or the SIMD processor 204 may be a memory device, such as a random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). The memory device may include instructions (e.g., the instructions 456) that, when executed by a computer (e.g., the processor 202, and/or the SIMD processor 204), may cause the computer to perform the method 300 of FIG. 3. As an example, the memory 203 or the one or more components of the processor 202 and/or the SIMD processor 204 may be a non-transitory computer-readable medium that includes instructions (e.g., the instructions 456) that, when executed by a computer (e.g., the processor 202 and/or the SIMD processor 204), cause the computer perform the method 300 of FIG. 3.

According to one implementation, the device 400 may be included in a system-in-package or system-on-chip device 422, such as a mobile station modem (MSM). According to one implementation, the processor 202, the SIMD processor 204, the display controller 426, the memory 432, the CODEC 434, the wireless controller 440, and the transceiver 450 are included in a system-in-package or the system-on-chip device 422. According to one implementation, an input device 430, such as a touchscreen and/or keypad, and a power supply 444 are coupled to the system-on-chip device 422. Moreover, according to one implementation, as illustrated in FIG. 4, the display 428, the input device 430, the speaker 448, the microphone 446, the antenna 442, and the power supply 444 are external to the system-on-chip device 422. However, each of the display 428, the input device 430, the speaker 448, the microphone 446, the antenna 442, and the power supply 444 can be coupled to a component of the system-on-chip device 422, such as an interface or a controller. The device 400 corresponds to a mobile communication device, a smartphone, a cellular phone, a laptop computer, a computer, a tablet computer, a personal digital assistant, a display device, a television, a gaming console, a music player, a radio, a digital video player, an optical disc player, a tuner, a camera, a navigation device, or any combination thereof.

In conjunction with the described implementations, an apparatus includes means for performing a query to determine a hardware vector length of a SIMD processor. For example, the means for performing the query may include the processor 202 of FIGS. 2 and 4, the control register 206 of FIGS. 2 and 4, the hypervisor 208 of FIGS. 2 and 4, one or more other devices, circuits, modules, or any combination thereof.

The apparatus may also include means for scaling a first SIMD instruction to a first scaled vector length to generate a first scaled instruction. The first scaled vector length may be based on the hardware vector length. For example, the means for scaling the first SIMD instruction may include the instruction scaling module 222 of FIGS. 2 and 4, one or more other devices, circuits, modules, or any combination thereof.

The apparatus may also include means for adjusting a first number of iterations to be used by the SIMD processor to perform first operations associated with the first SIMD instruction based on the first scaled vector length. For example, the means for adjusting the first number of iterations may include the processor 202 of FIGS. 2 and 4, one or more other devices, circuits, modules, or any combination thereof.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A method for executing scalable single-instruction-multiple-data (SIMD) instructions, the method comprising:
performing a query to determine a hardware vector length of a SIMD processor;
scaling a first instruction of the scalable SIMD instructions to a first scaled vector length to generate a first scaled instruction, the first scaled vector length based on the hardware vector length, wherein the first instruction is a compiled instruction having an adaptable vector length; and
adjusting a first number of iterations to be used by the SIMD processor to perform first operations associated with the first instruction based on the first scaled vector length.

2. The method of claim 1, wherein the query is performed at run-time.

3. The method of claim 1, wherein performing the query comprises polling a control register to determine the hardware vector length.

4. The method of claim 1, wherein performing the query comprises executing a dedicated scalar instruction to determine the hardware vector length.

5. The method of claim 1, wherein performing the query comprises executing hypervisor code to retrieve a value that indicates the hardware vector length.

6. The method of claim 1, wherein performing the query comprises performing a library call to access hardware specification data, the hardware specification data indicating the hardware vector length.

7. The method of claim 1, wherein performing the query comprises:
sending a software request for a range of hardware vector lengths for available resources, the software request sent to a library, an operating system, or both; and
receiving a signal indicating the hardware vector length when the SIMD processor is available to process data.

8. The method of claim 1, wherein performing the query comprises:
sending a software request for a particular hardware vector length of an available resource, the software request sent to a library, an operating system, or both; and
receiving a signal indicating the particular hardware vector length.

9. The method of claim 1, further comprising initiating execution of the first scaled instruction at the SIMD processor, wherein the SIMD processor performs the first operations using the adjusted first number of iterations to execute the first scaled instruction.

10. The method of claim 1, further comprising:
scaling other instructions of the scalable SIMD instructions to the first scaled vector length to generate additional scaled instructions; and
adjusting a number of iterations to be used by the SIMD processor to perform operations associated with the other instructions based on the first scaled vector length; and
initiating execution of the additional scaled instructions at the SIMD processor.

11. An apparatus comprising:
a processor configured to:
retrieve a first single-instruction-multiple-data (SIMD) instruction; and
scale the first SIMD instruction to a first scaled vector length to generate a first scaled instruction, the first scaled vector length based on a hardware vector length of a SIMD processor, wherein the first SIMD instruction is a compiled instruction having an adaptable vector length; and
a loop value register storing a control value that indicates a number of iterations to be used by the SIMD processor to perform operations associated with the first SIMD instruction, wherein the control value is adjusted based on the first scaled vector length.

12. The apparatus of claim 11, wherein the processor is the SIMD processor.

13. The apparatus of claim 11, wherein the processor is further configured to:
poll a control register to determine the hardware vector length; or
execute a dedicated scalar instruction to determine the hardware vector length.

14. The apparatus of claim 11, wherein the processor is further configured to execute hypervisor code to retrieve a value that indicates the hardware vector length.

15. The apparatus of claim 11, wherein the processor is further configured to:
send a software request for a range of hardware vector lengths for available resources, the software request sent to a library, an operating system, or both; and
receive a signal indicating the hardware vector length when the SIMD processor is available to process data.

16. The apparatus of claim 11, wherein the processor is further configured to:
send a software request for a particular hardware vector length of an available resource, the software request sent to a library, an operating system, or both; and
receive a signal indicating the particular hardware vector length.

17. A non-transitory computer-readable medium comprising commands for executing scalable single-instruction-multiple-data (SIMD) instructions, the commands, when executed by a processor, cause the processor to perform operations comprising:
performing a query to determine a hardware vector length of a SIMD processor;
scaling a first instruction of the scalable SIMD instructions to a first scaled vector length to generate a first scaled instruction, the first scaled vector length based on the hardware vector length, wherein the first instruction is a compiled instruction having an adaptable vector length; and
adjusting a first number of iterations to be used by the SIMD processor to perform first operations associated with the first instruction based on the first scaled vector length.

18. The non-transitory computer-readable medium of claim 17, wherein performing the query comprises:
sending a software request for a range of hardware vector lengths for available resources, the software request sent to a library, an operating system, or both; and
receiving a signal indicating the hardware vector length when the SIMD processor is available to process data.

19. The non-transitory computer-readable medium of claim 17, wherein performing the query comprises:
sending a software request for a particular hardware vector length of an available resource, the software request sent to a library, an operating system, or both; and
receiving a signal indicating the particular hardware vector length.

20. The non-transitory computer-readable medium of claim 17, wherein the processor is the SIMD processor.
